(19) United States
(12) Patent Application Publication
(10) Pub. No.: US 2019/0203611 A1
(43) Pub. Date: Jul. 4, 2019

(54) Combustor Assembly for a Turbine Engine

(71) Applicant: General Electric Company, Schenectady, NY (US)

(72) Inventors: Michael Alan Stieg, Cincinnati, OH (US); Nicholas John Bloom, Maineville, OH (US); Eric Ryan Newburn, Cincinnati, OH (US); Brett Joseph Geiser, Cincinnati, OH (US)

(21) Appl. No.: 15/860,804

(22) Filed: Jan. 3, 2018

(51) Int. Cl. F01D 25/10; F01D 19/02; F02C 9/18; F23R 3/00; F23R 3/04

(52) U.S. Cl. CPC F01D 25/10; F01D 19/02; F02C 9/18; F23R 3/002; F05D 2260/941; F23R 3/04; F05D 2220/323; F05D 2300/6033; F05D 2240/35; F23R 3/007

(57) ABSTRACT

A combustor assembly for a gas turbine engine includes a dome defining a slot. The combustor assembly also includes a liner at least partially defining a combustion chamber and extending between an aft end and a forward end. At least a portion of the forward end is received within the slot of the dome. The forward end of the liner defines a plurality of warming holes that allow for a warming airflow to flow therethrough to warm the forward end at a faster rate during transient operating conditions of the engine thereby reducing transient stresses and increasing liner durability.

### FEDERALLY SPONSORED RESEARCH

This invention was made with government support under contact number FA8626-16-C-2138 awarded by the Department of the Air Force. The U.S. government may have certain rights in the invention.

### FIELD

The present subject matter relates generally to gas turbine engines, and more particularly to combustor assemblies for gas turbine engines.

### BACKGROUND

A gas turbine engine generally includes a fan and a core arranged in flow communication with one another. Additionally, the core of the gas turbine engine general includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

More commonly, non-traditional high temperature materials, such as ceramic matrix composite (CMC) materials, are being used as structural components within gas turbine engines. For example, given the ability of CMC materials to withstand relatively extreme temperatures, there is particular interest in replacing components within the combustion section of the gas turbine engine with CMC materials. More particularly, inner and outer liners of gas turbine engines are more commonly being formed of CMC materials.

During normal operation, it is common for gas turbine engines to be required to rapidly increase thrust. During such rapid power increases or transient state conditions, combustion gases are generated within a combustion chamber defined by inner and outer liners. As the combustion gases flow downstream through the combustion chamber, the combustion gases scrub along the liners, causing the liners to rapidly heat up. However, the forward ends of the liners, or the portions of the liners that attach with dome sections, typically do not heat up as quickly as the rest of their respective liners. The thermal lag at the forward ends of the liners may cause undesirable bending stress and strain on the liners. As gas turbine engines may undergo many rapid power increases over many engine cycles, such repeated stress and strain on the liners can negatively impact their durability.

Accordingly, a combustor assembly of a gas turbine engine that includes features that reduce the stress and strain on combustion liners of the combustor assembly during rapid power increases of the gas turbine engine would be useful.

### BRIEF DESCRIPTION

Aspects and advantages of the invention will be set forth in part in the following description, or may be obvious from the description, or may be learned through practice of the invention.

In one exemplary embodiment of the present disclosure, a combustor assembly for a gas turbine engine is provided. The gas turbine engine defines an axial direction, a radial direction, and a circumferential direction. The combustor assembly includes a liner at least partially defining a combustion chamber and extending between an aft end and a forward end, the liner comprising an outer surface and an opposing inner surface, wherein the forward end of the liner defines a plurality of mounting openings spaced along the circumferential direction and a plurality of warming openings extending between the outer surface and the inner surface of the forward end.

In another exemplary aspect of the present disclosure, a method for warming a forward end of a liner of a combustor assembly for a gas turbine engine is provided. The combustor assembly includes a dome defining a slot, the forward end of the liner received within the slot. The method includes operating the gas turbine engine to generate a warming airflow. The method also includes flowing the warming airflow through a plurality of warming openings defined by the forward end of the liner, wherein the plurality of warming openings extend between an outer surface and an opposing inner surface of the forward end of the liner.

In yet another exemplary aspect of the present disclosure, a combustor assembly for a gas turbine engine is provided. The combustor assembly includes a liner formed of a ceramic matrix composite (CMC) material. The liner extends between a forward end and a second end. The forward end of the liner defines a plurality of mounting openings spaced circumferentially about the forward end. In addition, the forward end further defines a plurality warming openings extending therethrough.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic cross-sectional view of an exemplary gas turbine engine according to various embodiments of the present subject matter;

FIG. 2 provides a schematic, cross-sectional view of a combustor assembly in accordance with an exemplary embodiment of the present disclosure;

FIG. 3 provides a close up, cross-sectional view of an attachment point of the exemplary combustor assembly of FIG. 2, where a forward end of an outer liner in accordance with an exemplary embodiment of the present disclosure is attached to an outer dome section;

FIG. 4 provides a close up, perspective view of the outer liner of FIG. 2 depicting a plurality of warming regions each including a plurality of warming openings extending through the forward end of the outer liner;

FIG. 5 provides a close up, cross-sectional view of the forward end of the outer liner of FIG. 2 depicting warming openings through the forward end; and

FIG. 6 provides a flow diagram of an exemplary method for warming a liner of a combustor assembly of a gas turbine engine in accordance with an exemplary embodiment of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “forward” and “aft” refer to relative positions within a gas turbine engine, with forward referring to a position closer to an engine inlet and aft referring to a position closer to an engine nozzle or exhaust. The terms “upstream” and “downstream” refer to the relative direction with respect to fluid flow in a fluid pathway. For example, “upstream” refers to the direction from which the fluid flows, and “downstream” refers to the direction to which the fluid flows. It should be appreciated, that as used herein, terms of approximation, such as “about” and “approximately,” refer to being within a ten percent (10%) margin of error.

Exemplary aspects of the present disclosure are directed to a combustor assembly and liners of combustor assemblies for gas turbine engines. In one exemplary aspect, the combustor assembly includes a dome defining a slot and a liner that at least partially defines a combustion chamber. The liner extends between an aft end and a forward end. At least a portion of the forward end is received within the slot of the dome. The forward end of the liner defines a plurality of warming holes that allow for a warming airflow to flow therethrough to warm the forward end at a faster rate during transient operating conditions of the engine, particularly during rapid power increases or bursts of the engine. In this way, the stress and strain on the liner during such transient operating conditions may be reduced, thereby improving the durability of the liners. Methods for warming the forward end of combustion liners are also provided.

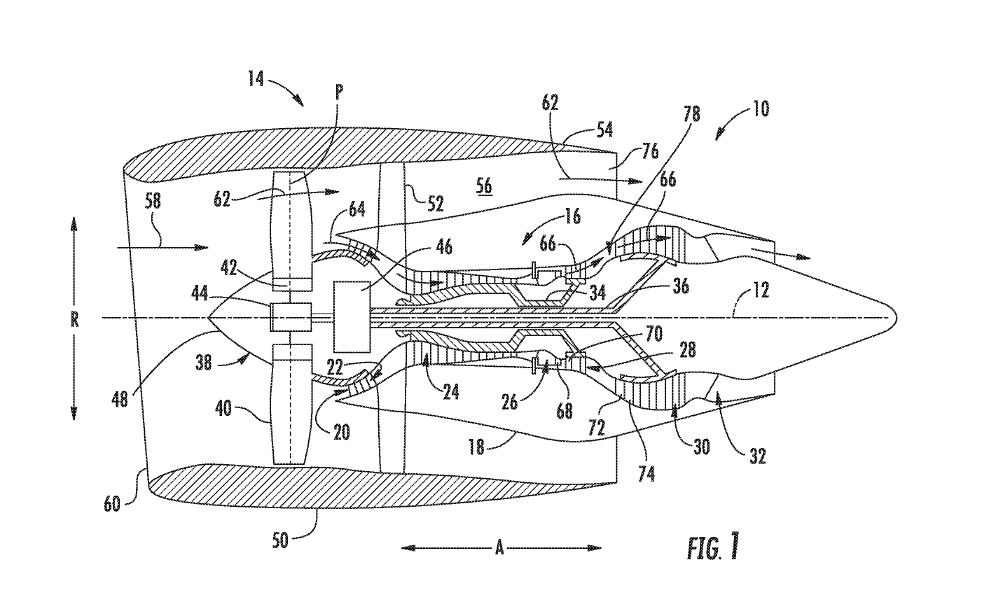

FIG. 1 provides a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference), a radial direction R, and a circumferential direction (i.e., a direction extending about the axial direction A; not depicted). In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the embodiment depicted, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40 in unison. The fan blades 40, disk 42, and actuation member 44 are together rotatable about the longitudinal axis 12 by LP shaft 36 across a power gear box 46. The power gear box 46 includes a plurality of gears for stepping down the rotational speed of the LP shaft 36 to a more efficient rotational fan speed.

Referring still to the exemplary embodiment of FIG. 1, the disk 42 is covered by rotatable spinner or front nacelle 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that the nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass airflow passage 56 therebetween.

During operation of the turbofan engine 10, a volume of air 58 enters the turbofan 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated that the exemplary turbofan engine 10 depicted in FIG. 1 is by way of example only, and that in other exemplary embodiments, the turbofan engine 10 may have any suitable configuration. For example, the present disclosure matter may be suitable for use with or in turboprops, turboshafts, turbojets, reverse-flow engines, industrial and marine gas turbine engines, and/or auxiliary power units.

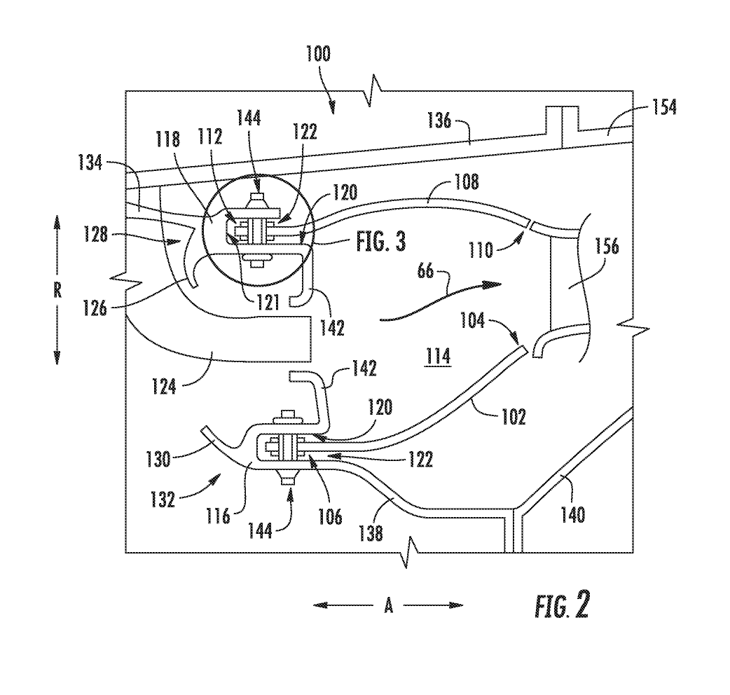

FIG. 2 provides a close-up cross-sectional view of a combustor assembly 100 in accordance with an exemplary embodiment of the present disclosure. For example, the combustor assembly 100 of FIG. 2 may be positioned in the combustion section 26 of the exemplary turbofan engine 10 of FIG. 1. More particularly, FIG. 2 provides a side, cross-sectional view of the exemplary combustor assembly 100 of FIG. 2.

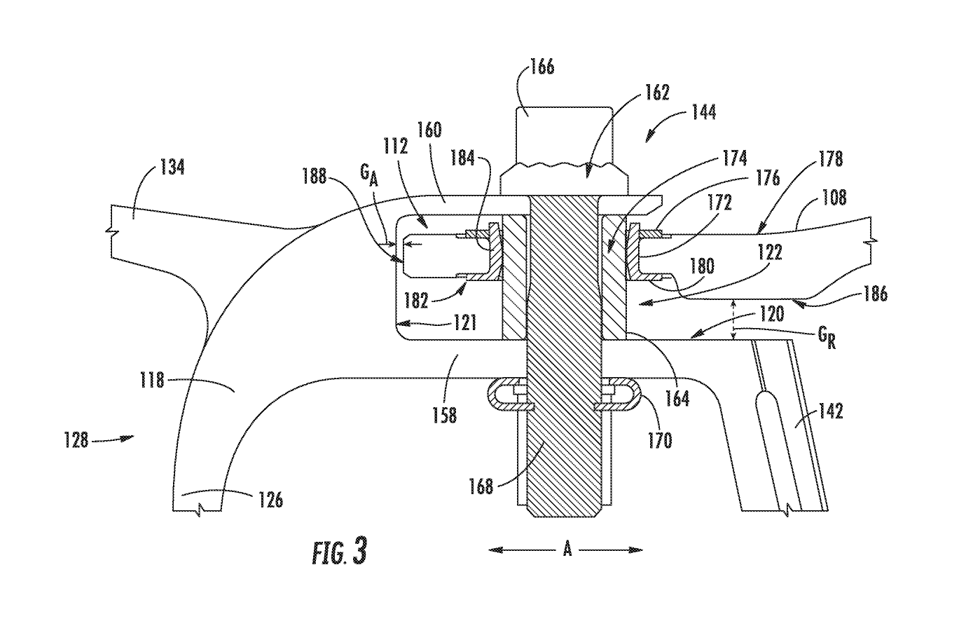

As shown, the combustor assembly 100 includes an inner liner 102 extending between an aft end 104 and a forward end 106 generally along the axial direction A, as well as an outer liner 108 also extending between an aft end 110 and a forward end 112 generally along the axial direction A. The inner and outer liners 102, 108 together at least partially define a combustion chamber 114 therebetween. The inner and outer liners 102, 108 are each attached to an annular dome. More particularly, the annular dome includes an inner dome section 116 attached to the forward end 106 of the inner liner 102 and an outer dome section 118 attached to the forward end 112 of the outer liner 108. The inner and outer dome sections 116, 118 may be formed integrally (or alternatively may be formed of a plurality of components attached in any suitable manner) and may each extend along the circumferential direction C to define an annular shape. As will be discussed in greater detail below with reference to FIG. 3, the inner and outer dome sections 116, 118 each include a forward surface 120 and an inner surface 121 (i.e., inner relative to the combustion chamber 114) at least partially defining a slot 122 for receipt of the forward end 106 of the inner liner 102, and the forward end 112 of the outer liner 108, respectively.

The combustor assembly 100 further includes a plurality of fuel air mixers 124 spaced along a circumferential direction C and positioned at least partially within the annular dome. More particularly, the plurality of fuel air mixers 124 are disposed at least partially between the outer dome section 118 and the inner dome section 116 along the radial direction R. Compressed air from the compressor section of the turbofan engine 10 flows into or through the fuel air mixers 124, where the compressed air is mixed with fuel and ignited to create the combustion gases 66 (FIG. 1) within the combustion chamber 114. The inner and outer dome sections 116, 118 are configured to assist in providing such a flow of compressed air from the compressor section into or through the fuel air mixers 124. For example, the outer dome section 118 includes an outer cowl 126 at a forward end 128 and the inner dome section 116 similarly includes an inner cowl 130 at a forward end 132. The outer cowl 126 and inner cowl 130 may assist in directing the flow of compressed air from the compressor section into or through one or more of the fuel air mixers 124.

Moreover, the inner and outer dome sections 116, 118 each include attachment portions configured to assist in mounting the combustor assembly 100 within the turbofan engine 10 (FIG. 1). For example, the outer dome section 118 includes an attachment extension 134 configured to be mounted to an outer combustor casing 136 (not shown in FIG. 2) and the inner dome section 116 includes a similar attachment extension 138 configured to attach to an annular support member 140 within the turbofan engine 10. In certain exemplary embodiments, the inner dome section 116 may be formed integrally as a single annular component, and similarly, the outer dome section 118 may also be formed integrally as a single annular component. It should be appreciated, however, that in other exemplary embodiments, the inner dome section 116 and/or the outer dome section 118 may alternatively be formed by one or more components being joined in any suitable manner. For example, with reference to the outer dome section 118, in certain exemplary embodiments, the outer cowl 126 may be formed separately from the outer dome section 118 and attached to the forward end 128 of the outer dome section 118 using, e.g., a welding process. Similarly, the attachment extension 134 may also be formed separately from the outer dome section 118 and attached to the forward end 128 of the outer dome section 118 using, e.g., a welding process. Additionally or alternatively, the inner dome section 116 may have a similar configuration.

With reference still to FIG. 2, the exemplary combustor assembly 100 further includes a heat shield 142 positioned around the fuel air mixer 124 depicted. For this embodiment, the exemplary heat shield 142 is attached to and extends between the outer dome section 118 and the inner dome section 116. The heat shield 142 is configured to protect certain components of the turbofan engine 10 (FIG. 1) from the relatively extreme temperatures of the combustion chamber 114.

For the embodiment depicted, the inner liner 102 and the outer liner 108 are each formed of a ceramic matrix composite (CMC) material, which is a non-metallic material having high temperature capability. Exemplary CMC materials utilized for such liners 102, 108 may include silicon carbide, silicon, silica or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y and combinations thereof) and inorganic fillers (e.g., pyrophyllite, wollastonite, mica, talc, kyanite and montmorillonite). CMC materials may have coefficients of thermal expansion in the range of about 1.3×10⁻⁶ in/in/° F. to about 3.5×10⁻⁶ in/in/° F. in a temperature of approximately 1000-1200° F.

By contrast, the annular dome, including the inner dome section 116 and outer dome section 118, may be formed of a metal, such as a nickel-based superalloy (having a coefficient of thermal expansion of about 8.3-8.5×10⁻⁶ in/in/° F. in a temperature of approximately 1000-1200° F.) or cobalt-based superalloy (having a coefficient of thermal expansion of about 7.8-8.1×10⁻⁶ in/in/° F. in a temperature of approximately 1000-1200° F.).

Referring still to FIG. 2, as noted above, the combustion gases 66 (FIG. 1) flow from the combustion chamber 114 into and through the turbine section of the turbofan engine 10 (FIG. 1) where a portion of thermal and/or kinetic energy from the combustion gases 66 is extracted via sequential stages of turbine stator vanes and turbine rotor blades. A stage one (1) turbine nozzle 156 is depicted schematically in FIG. 2 positioned aft of the combustor assembly 100.

FIG. 3 provides a close up, schematic, cross-sectional view of an attachment point where the forward end 112 of the outer liner 108 is mounted to the outer dome section 118 within the slot 122 of the outer dome section 118. To allow for a relative thermal expansion between the outer liner 108 and the outer dome section 118, as well as between the inner liner 102 and the inner dome section 116 (FIG. 2), a plurality of mounting assemblies 144 are used to attach the outer liner 108 to the outer dome section 118 and the inner liner 102 to the inner dome section 116. More particularly, the mounting assemblies 144 attach the forward end 112 of the outer liner 108 to the outer dome section 118 within the slot 122 of the outer dome section 118 as shown in FIGS. 2 and 3 and the forward end 106 of the inner liner 102 to the inner dome section 116 within the slot 122 of the inner dome section 116 (FIG. 2). The slots 122 are defined by their respective domes. Moreover, the slots 122 receive the forward ends 106, 112 of the inner and outer liners 102, 108, respectively.

Referring particularly to the forward end 112 of the outer liner 108 and the outer dome section 118 depicted in FIG. 3, the outer dome section 118 includes a base plate 158 and a yolk 160. The base plate 158 and the yolk 160 are spaced along the radial direction R. The base plate 158 and the yolk 160 each extend substantially parallel to one another, which for the embodiment depicted is a direction substantially parallel to the axial direction A of the turbofan engine 10 (see also FIG. 2). Notably, the slot 122 is defined between the base plate 158 and the yolk 160. The slot 122 is further defined by the forward surface 121. Further, in certain exemplary embodiments, the yolk 160 may extend circumferentially with the outer dome section 118, tracking the base plate 158. With such a configuration, the slot 122 may be considered an annular slot. However, in other embodiments, the yolk 160 may include a plurality of circumferentially spaced tabs, each of the individual tabs of the yolk 160 defining individual segmented portions of the slot 122 with the base plate 158.

The exemplary mounting assembly 144 depicted includes the yolk 160 of the outer dome section 118 and the base plate 158 of the outer dome section 118. Moreover, the mounting assembly 144 includes a pin 162 and a bushing 164. The pin 162 includes a head 166 and a shank 168. The shank 168 extends through the yolk 160, the forward end 112 of the outer liner 108 (positioned in slot 122), and the base plate 158. A nut 170 is attached to a distal end of the shank 168 of the pin 162. In certain exemplary embodiments, the pin 162 may be configured as a bolt and the nut 170 may be rotatably engaged with a threaded portion of the pin 162 (at, e.g., the distal end of the shank 168) for tightening the mounting assembly 144. Alternatively, however, in other exemplary embodiments the pin 162 and nut 170 may have any other suitable configurations. In other exemplary embodiments, for instance, the pin 162 may include a shank 168 defining a substantially smooth cylindrical shape and the nut 170 may be configured as a clip.

Additionally, the bushing 164 is generally cylindrical in shape and is positioned around the shank 168 of the pin 162 within the slot 122. For the embodiment depicted, the bushing 164 is pressed between the yolk 160 and the base plate 158 by tightening the nut 170 on the pin 162. Moreover, for the embodiment depicted, the mounting assembly 144 includes a metal grommet 172 positioned around the bushing 164 and pin 162. The grommet 172 is positioned in a mounting opening 174 defined by the forward end 112 of the outer liner 108. The grommet 172 includes an outer collar 176 positioned adjacent to an outer surface 178 of the outer liner 108 and an inner collar 180 positioned adjacent to an inner surface 182 of the outer liner 108. The grommet 172 additionally includes a body 184. The metal grommet 172 may reduce an amount of wear on the forward end 112 of the outer liner 108 as the outer liner 108 moves inwardly and outwardly generally along the radial direction R relative to the outer dome section 118.

It should be appreciated, however, that although the forward end 112 of the outer liner 108 is attached to the outer dome section 118 using the exemplary mounting assembly 144 depicted and described herein, in other embodiments of the present disclosure, the mounting assembly 144 may have other suitable configurations, and further still in other embodiments, any other suitable attachment assembly may be used.

Referring still to FIG. 3, the forward end 112 of the outer liner 108 depicted further includes an axial interface surface 186 and a radial interface surface 188. The axial interface surface 186 is configured as a portion of the forward end 112 of the outer liner 108 facing the base plate 158 of the outer dome section 118, or more particularly, facing the inner surface 120 of the outer dome section 118. The radial interface surface 188 is configured as a portion of the forward end 112 of the outer liner 108 facing the forward surface 121 of the outer dome section 118. For the embodiment depicted, the axial interface surface 186 and inner surface 120 each extend in a direction parallel to the axial direction A, and the radial interface surface 188 and forward surface 121 each extend in a direction parallel to the radial direction R.

Moreover, as further shown in FIG. 3, the axial interface surface 186 defines a radial gap G_{R} with the inner surface 120 of the outer dome section 118 and the radial interface surface 188 defines an axial gap G_{A} with the forward surface 121 of the outer dome section 118. The combustor assembly 100 may be designed such that the radial and axial gaps G_{R}, G_{A} allow for only a predetermined amount of airflow therethrough into the combustion chamber 114. Notably, allowing such a flow of air during operating conditions of the combustor assembly 100 may ensure relatively hot combustion gases within the combustion chamber 114 do not flow into and/or through the slot 122 of the outer dome section 118, potentially damaging certain components of the combustor assembly 100.

In addition to the airflow through the radial and axial gaps G_{R}, G_{A}, in some exemplary embodiments as will be explained more fully below, additional airflow can be provided through warming openings defined by the forward end 112 of the outer liner 108 (as well as the forward end 106 of the inner liner 102 depicted in FIG. 2) to improve the thermal response (e.g., reduce the thermal lag) of the forward ends 112, 106 of the outer and inner liners 108, 102 during transient operation of the turbofan engine 10 (FIG. 1), and particularly during rapid power increases or bursts of the turbofan engine 10. In this way, the stress and strain on the outer and inner liners 108, 102 can be reduced during transient operation of the engine.

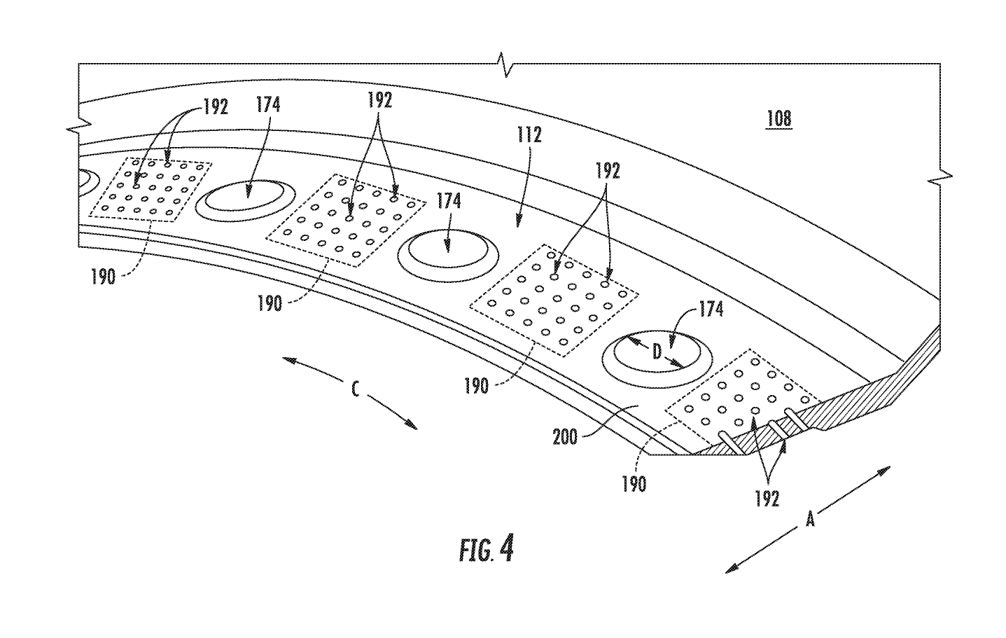

FIG. 4 provides a perspective, partial cross sectional view of the outer liner 108 of FIG. 2 depicting a plurality of warming regions 190 in which warming openings 192 are defined by the forward end 112 of the outer liner 108. As shown, the warming regions 190 are defined adjacent the plurality of mounting openings 174, and thus, the warming regions 190 are also defined adjacent the mounting assemblies 144 (FIG. 3). More particularly, for this embodiment, the warming regions 190 are defined or positioned between each of the mounting openings 174 along the circumferential direction C. That is, the warming regions 190 are interspersed with the mounting openings 174 along the circumferential direction C. In some embodiments, the warming regions 190 can be defined about the plurality of mounting openings 174. Stated alternatively, the warming regions 190 can extend forward and aft of the mounting openings 174 along the axial direction A, as well as on both sides of the mounting openings 174 along the circumferential direction C (e.g., as shown in FIG. 4). In yet other embodiments, the entire annular forward end 112 of the outer liner 108 may be considered the warming region 190.

Further, as shown in FIG. 4, the forward end 112 of the outer liner 108 defines a plurality of warming openings 192 within each of the warming regions 190, as noted above. In the depicted embodiment of FIG. 4, each warming region 190 includes twenty-five (25) warming openings 192. It will be appreciated, however, that the warming regions 190 can include more or less warming openings 192 than twenty-five (25) warming openings 192. In some embodiments, the forward end 112 of the outer liner 108 defines one or more of the plurality of warming openings 192 adjacent each of the plurality of mounting openings 174. Stated differently, in such embodiments, each mounting opening 174 (and mounting assembly 144) spaced along the circumferential direction C may have warming openings 192 positioned adjacent. In this way, warming openings 192 are defined by the forward end 112 generally about the entire annular outer liner 108. In some embodiments, the forward end 112 of the outer liner 108 defines the plurality of warming openings 192 between and about each of the plurality of mounting openings 174. The warming openings 192 will be further described below.

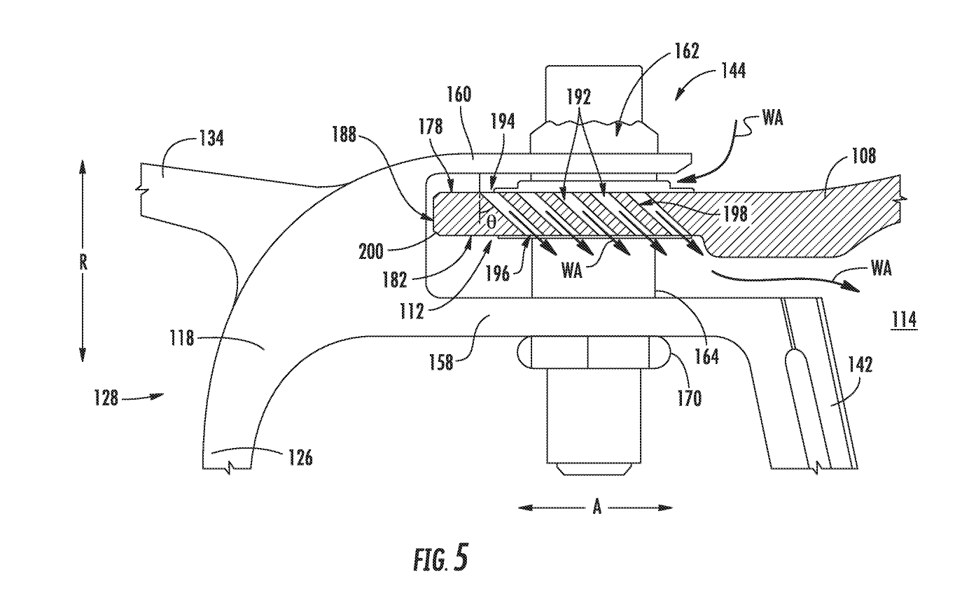

FIG. 5 provides a close up, cross-sectional view of warming openings 192 defined by the forward end 112 of the outer liner 108 of the combustor assembly 100. More particularly, for this embodiment, the forward end 112 of the outer liner 108 defines the warming openings 192 that each extend between the outer surface 178 and the inner surface 182 of the forward end 112. In some embodiments, the diameter of the warming openings 192 may range between or about between 0.020 and 0.080 inches (0.508-2.032 mm). The diameter of the mounting openings 174 may range between or about between 0.400 and 0.800 inches (10.16-20.32 mm). Thus, in such embodiments, the mounting openings 174 have substantially larger diameters than the warming openings 192.

For the depicted embodiment of FIG. 5, the warming openings 192 are shown angled with respect to the radial direction R. As shown, the outer surface 178 of the outer liner 108 defines an outer end 194 of each of the plurality of warming openings 192 and the inner surface 182 of the outer liner 108 defines an inner end 196 of each of the plurality of warming openings 192. Thus, the warming openings 192 each extend between their respective outer and inner ends 194, 196. As shown in the embodiment of FIG. 5, the inner ends 196 of the warming openings 192 are positioned or defined aft of the outer ends 194. Stated alternatively, the inner ends 196 of the warming openings 192 are defined downstream of the outer ends 194 of the warming openings 192. The warming openings 192 are angled with their respective inner ends 196 positioned aft of their respective outer ends 194 to facilitate efficient warming airflow through the warming openings 192, which allows for an improved thermal response of the forward end 112 (e.g., it allows the forward end 112 to more rapidly heat up). Moreover, the orientation of the warming openings 192 in FIG. 5 facilitate warming airflow WA across the inner surface 182 of the outer liner 108, which further causes the forward end 112 to heat up more rapidly.

Additionally, for the depicted embodiment of FIG. 5, the plurality of warming openings 192 are oriented at an angle θ with respect to the radial direction R. More particularly, for this embodiment, the warming openings 192 are angled at a forty-five degree (45°) angle with respect to the radial direction R. By angling the warming openings 192, the surface area of the sidewalls 198 defining the warming openings 192 is increased, thereby facilitating heat transfer and more rapid heating of the forward end 112. In yet other embodiments, the warming openings 192 are angled at a sixty degree (60°) angle with respect to the radial direction R, thereby further increasing the surface area of the sidewalls 198 defining the warming openings 192. In yet other embodiments, the warming openings 192 are angled at a seventy-five degree (75°) angle with respect to the radial direction R. In some embodiments, the warming openings 192 are oriented at an angle that is greater than forty-five degrees (45°) with respect to the radial direction R. It yet further embodiments, the warming openings 192 are oriented approximately along the radial direction R. By orienting the warming openings 192 along approximately along the radial direction R, the openings may be easier to machine into the forward end 112 of the outer liner 108 and may be less impactful to the structural integrity of the forward end 112.

Further, as shown in FIG. 5 the forward end 112 defines at least one row of warming openings 192 spaced along the axial direction A a distance greater than a diameter D of one of the plurality of mounting openings 174. In some embodiments, a plurality of rows of warming openings 192 can be spaced along the axial direction A a distance greater than a diameter D of one of the plurality of mounting openings 174 (FIG. 4). For instance, as shown in FIG. 4, the forward end 112 of the outer liner 108 defines five (5) rows of warming openings 192. Each of the rows has five (5) warming openings 192. By including such rows made up of warming openings that extend an axial distance greater than the diameter D of the mounting openings 174, heat transfer is facilitated both forward and aft of the mounting openings 174 and mounting assemblies 144 along the axial direction A.

In some embodiments, the forward end 112 of the outer liner 108 includes a flange 200 that extends generally along the axial direction A and annularly about the circumferential direction C. In such embodiments, at least a portion of the flange 200 is received within the slot 122 defined by the outer dome 118 (e.g., between the yolk 160 and the base plate 158). Moreover, in such embodiments, the portion of the flange 200 that is received within the slot 122 defines at least one of the plurality of warming openings 192. For this embodiment, the portion of the flange 200 received within the slot 122 defines a plurality of warming openings 192.

During a rapid power increase of the turbofan engine, the temperature of the generated combustion gases increases. The high temperature combustion gases scrub along the outer and inner liners, which rapidly heats the liners. However, as noted previously, the forward ends of the liners do not heat up as quickly. Stated differently, the forward ends of the liners thermally lag the other portions of the liners. Consequently, the liners may experience bending stress and strain due to the thermal lag of the forward ends. To reduce the thermal lag and thus the stress and strain on the liners, the warmings openings allow for a warming airflow to flow therethrough to warm the forward ends of the inner and outer liners. In this way, the stress and strain on the liners can be reduced, thereby improving the durability of the liners.

With reference to FIG. 5, a warming airflow WA may flow through the warming openings 192 as follows. As shown, during operation of turbofan engine 10 (FIG. 1), the warming airflow WA flows into the slot 122 defined by the outer dome 118. More particularly, the warming air WA flows between the yoke 160 and the outer surface 178 of the outer liner 108. In this example, the warming airflow WA is compressor discharge air (P3 air). As the warming airflow WA travels forward along the axial direction A deeper into the slot 122, some of the warming airflow WA flows through the warming openings 192 as shown. The warming airflow WA flows through the warming openings 192 from their respective outer ends 194 to their respective inner ends 196 in a generally radially inward direction. As the warming airflow WA flows through the warming openings 192, convection heat transfer occurs. More specifically, the warming air WA flowing through the warming openings 192 exchanges heat with the sidewalls 198 of the openings 192, thus effectively warming the forward end 112 of the outer liner 108. Further, after exiting through the inner ends 196 of the warming openings 192, the warming airflow WA flows aft along the axial direction A and into the combustion chamber 114. Flowing the warming airflow WA through the warming openings 192 actively warms the forward end 112, particularly during transient bursts of the engine. Accordingly, the warming openings 192 increase the transient response rate of the forward end 112, which may reduce the bending stress and strain on the liner.

It will be appreciated that the forward end 106 of the inner liner 102 (FIG. 2) may be formed in the same or substantially the same manner as the forward end 112 of the outer liner 108 as described above. Further, it will be appreciated that the forward end 106 of the inner liner 102 may be attached to the inner dome section 116 in the same or substantially the same manner that the forward end 112 of the outer liner 108 is attached to the outer dome section 118. For example, the forward end 106 of the inner liner 102 may define a plurality of warming regions that each include a plurality of warming openings extending therethrough (e.g., as shown in FIGS. 4 and 5). Such warming openings can increase the thermal response of the forward end 106 of the inner liner 102 during rapid power increases of the turbofan engine 10 (FIG. 1), thereby reducing the bending stress and strain on the inner liner 102.

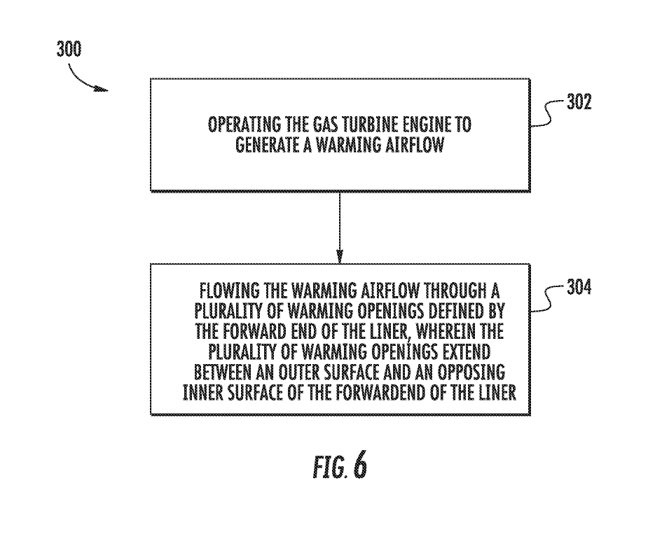

FIG. 6 provides a flow diagram of an exemplary method (300) for warming a liner of a combustor assembly of a gas turbine engine. The gas turbine engine can be, for example, the turbofan engine 10 of FIG. 1. The combustor assembly can be the combustor assembly 100 of FIG. 2 and the liner can be the inner and/or outer liners 102, 108 of FIG. 2. Accordingly, the combustor assembly may include a dome defining a slot. For instance, the dome can be the outer dome 118 or the inner dome 116. The forward end of the liner may be received within the slot. For instance, the forward end can be the forward end 112 of the outer liner 108 or the forward end 106 of the inner liner 102. In some implementations, the liner is formed CMC material and the dome is formed of a metal material.

At (302), the method includes operating the gas turbine engine to generate a warming airflow. For instance, the warming airflow can be generated by the gas turbine engine during a rapid power increase or burst of power. The warming airflow can be, for example, compressor discharge air flowing generally axially through a plenum that is defined radially outward of the outer liner 108 between the outer liner 108 and the outer combustor casing 136 (FIG. 2). As another example, the warming airflow can be compressor discharge air flowing generally axially through a plenum that is defined radially inward of the inner liner 102 between the inner liner 102 and the longitudinal centerline 12 (FIGS. 1 and 2).

At (304), the method includes flowing the warming airflow through a plurality of warming openings defined by the forward end of the liner, wherein the plurality of warming openings extend between an outer surface and an opposing inner surface of the forward end of the liner. For instance, as explained above with reference to FIG. 5, warming airflow WA flows into slot 122 during operation of the gas turbine engine. After flowing into the slot 122, the warming airflow WA flows through the plurality of warming openings 192. In the depicted embodiment, each of the warming openings 192 are through holes that extend between the outer surface 178 to the opposing inner surface 182 of the outer liner 108. Accordingly, the warming airflow WA flows through the outer liner 108. As the warming airflow WA flows through the warming openings 192, the warming airflow WA displaces the air within the openings (e.g., purge air from the combustion chamber 114) and exchanges heat with the sidewalls 198 of the warming openings 192. In this manner, the forward end 112 of the outer liner 108 may be warmed.

In yet other implementations of method (300), the outer surface of the liner defines an outer end of the plurality of warming openings and the inner surface of the liner defines an inner end of the plurality of warming openings, and wherein the inner ends of the plurality of warming openings are positioned aft of the outer ends of the plurality of warming openings. For instance, as shown in FIG. 5, the inner ends 196 of the plurality of warming openings 192 are positioned aft of the outer ends 194 of the plurality of warming openings 192. In some embodiments, the inner ends 196 of the plurality of warming openings 192 are positioned entirely aft of their respective outer ends 194. In yet other embodiments, the inner ends 196 of the plurality of warming openings 192 are positioned at least partially aft of their respective outer ends 194 (e.g., the diameters of the inner and outer ends 196, 194 overlap along the radial direction R).

In some implementations of method (300), the forward end of the liner comprises a flange, and wherein the flange is received within the slot and wherein the plurality of warming openings are defined by the flange. For instance, the flange can be the flange 200 of the forward end 112 shown in FIG. 5.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A combustor assembly for a gas turbine engine defining an axial direction, a radial direction, and a circumferential direction, the combustor assembly comprising:
a liner at least partially defining a combustion chamber and extending between an aft end and a forward end, the liner comprising an outer surface and an opposing inner surface, wherein the forward end of the liner defines a plurality of mounting openings spaced along the circumferential direction and a plurality of warming openings extending between the outer surface and the inner surface of the forward end.

2. The combustor assembly of claim 1, wherein the forward end of the liner defines a plurality of warming regions positioned between the plurality of mounting openings, and wherein the forward end of the liner defines one or more of the plurality of warming openings within each of the plurality of warming regions.

3. The combustor assembly of claim 1, wherein the forward end of the liner defines one or more of the plurality of warming openings adjacent each of the plurality of mounting openings.

4. The combustor assembly of claim 1, wherein the plurality of warming openings each have a diameter between about 0.020 and about 0.080 inches.

5. The combustor assembly of claim 1, wherein the forward end defines a row of warming openings spaced along the axial direction a distance greater than a diameter of one of the plurality of mounting openings.

6. The combustor assembly of claim 1, wherein the outer surface of the liner defines an outer end of each of the plurality of warming openings and the inner surface of the liner defines an inner end of each of the plurality of warming openings, and wherein the inner ends of the warming openings are positioned aft of the outer ends.

7. The combustor assembly of claim 1, wherein the plurality of warming openings are oriented at an angle with respect to the radial direction, wherein the angle is about forty-five degrees (45°) with respect to the radial direction.

8. The combustor assembly of claim 1, wherein the plurality of warming openings are oriented at an angle with respect to the radial direction, wherein the angle is about sixty degrees (60°) with respect to the radial direction.

9. The combustor assembly of claim 1, wherein the plurality of warming openings are oriented approximately along the radial direction.

10. The combustor assembly of claim 1, further comprising:
a dome defining a slot, wherein the forward end of the liner is received within the slot of the dome.

11. The combustor assembly of claim 10, wherein the liner is formed of a ceramic matrix composite (CMC) material, and wherein the dome is formed of a metal material.

12. The combustor assembly of claim 10, wherein the liner is an outer liner and wherein the dome is an outer dome section.

13. The combustor assembly of claim 10, wherein the dome comprises a yolk and a base plate spaced from the yolk along the radial direction, the yolk and the base plate defining the slot, and wherein the forward end of the liner comprises a flange, and wherein at least a portion of the flange is received within the slot, and wherein the portion of the flange received within the slot defines at least one of the plurality of warming openings.

14. A method for warming a forward end of a liner of a combustor assembly for a gas turbine engine, the combustor assembly comprising a dome defining a slot, the forward end of the liner received within the slot, the method comprising:
operating the gas turbine engine to generate a warming airflow; and
flowing the warming airflow through a plurality of warming openings defined by the forward end of the liner, wherein the plurality of warming openings extend between an outer surface and an opposing inner surface of the forward end of the liner.

15. The method of claim 14, wherein the forward end of the liner comprises a flange, and wherein the flange is received within the slot and wherein the plurality of warming openings are defined by the flange.

16. The method of claim 14, wherein the outer surface of the liner defines an outer end of the plurality of warming openings and the inner surface of the liner defines an inner end of the plurality of warming openings, and wherein the inner ends of the plurality of warming openings are positioned aft of the outer ends of the plurality of warming openings.

17. A combustor assembly for a gas turbine engine, the combustor assembly comprising:
a liner formed of a ceramic matrix composite (CMC) material and extending between a forward end and a second end, the forward end of the liner defining a plurality of mounting openings spaced circumferentially about the forward end, the forward end further defining a plurality warming openings extending therethrough.

18. The combustor assembly of claim 17, further comprising:
a dome defining a slot;
a plurality of mounting assemblies coupling the forward end of the liner with the dome, wherein each mounting assembly comprises a pin received within one of the plurality of mounting openings.

19. The combustor assembly of claim 17, wherein the forward end of the liner defines a plurality of warming regions positioned adjacent the plurality of mounting openings along the circumferential direction, and wherein the forward end of the liner defines one or more of the plurality of warming openings within each of the plurality of warming regions.

20. The combustor assembly of claim 17, wherein the plurality of warming openings are oriented at an angle with respect to the radial direction, wherein the angle is greater than forty-five degrees (45°) with respect to the radial direction.
